(19) United States
(12) Patent Application Publication
(10) Pub. No.: US 2013/0282602 A1
(43) Pub. Date: Oct. 24, 2013

(54) TaxiZag

(71) Applicant: Yingjie Wang, (US)

(72) Inventor: Yingjie Wang, (US)

(21) Appl. No.: 13/366,346

(22) Filed: Apr. 18, 2012

(51) Int. Cl. G06Q 50/30

(52) U.S. Cl. 705/319

(57) ABSTRACT

TaxiZag is a real-time software system that is implemented on the platform of cloud computing and smart phones. The system can be used by both taxi customers and taxi drivers for intelligently finding a taxi and a customer, respectively. The system is designed to achieve the most efficient and direct communication between a taxi customer and a taxi driver. The users of TaxiZag, in an automated fashion, feed data into and fetch data from the backend cloud computing platform to assist yourself and others. Additionally, users are allowed to check traffic conditions ahead based on the data provided by other application users.

### 1. BACKGROUND

TaxiZag is an Intelligent Transportation System, which is implemented on the platform of the latest Information Technology and Location-based Service.

TaxiZag creatively and intelligently brings together individuals looking to hire taxies and taxi drivers wanting to pick up customers. This mobile phone application, which is used by the taxi drivers and the taxi customers, displays available taxis and prospective customers on a map.

A taxi driver can find a place to park after dropping off a customer and wait for a call from a new customer, or take the initiative to find a customer. The taxi drivers do not have to keep driving on the road for looking for customers, which not only eases the road traffic, and also greatly reduce environmental pollution and significantly save resources, such as gas and taxi mileage. The application will assist taxi drivers to save energy, reduce idle time, increase amount of customers, and then increase revenue. Using the application, a taxi customer will save time in getting a taxi.

### 2. SUMMARY OF THE INVENTION

Mobile phone users can get an available taxi with the highest efficiency and the shortest possible time. The most effective direct communication is introduced and employed between a taxi customer and taxi driver. This feature also solves the practical problem, which is particularly difficult to get a taxi in the shifting time period of taxi drivers. Additionally, taxi drivers and customers can use the application to view the traffic condition ahead and adjust route at any time.

### 3. SYSTEM DESCRIPTION

When application starts, it reads its locally saved configuration setting. If there are no settings saved (first time use) it asks if the application is being used by a customer or a taxi driver. TaxiZag stores the answer into the configuration setting. When a taxi driver turns on the application, the taxi will be specified as vacant (available) and its location will be displayed on the center of the map as an available taxi icon. The customers that are found will be showing on the map as customer icons.

Since both available and unavailable taxis and customers are shown on the map, the icon color would distinguish them as available or unavailable.
Taxi: Green (available); Grey (unavailable)
Customer: Blue (available); Pink (unavailable)

When a customer turns on the application, it is assumed that he is available and looking for a taxi. His location and icon will be shown at the center of the map. The map will also show all available and unavailable taxis as well as other customers.

Both customers and taxi drivers view the same base map on their mobile phone. The map displays a two-mile area with the location of the application's user at its center. The taxis and customers are dynamically displayed on the map within the two mile area (one mile radius). The map is continuously updated showing the icons for the latest positions of the taxis and customers.

The information can be edited later through the “Setting” button. When a customer taps a taxi icon, a popup text box will show the basic information about the taxi driver, such as company name, and cell phone number. Customer's icon is not touchable (no information to display). A customer can tap the phone number to call the taxi driver.

The balloon box of the taxi icon will display the following information:
Available/Unavailable
Taxi Company Name
Current Speed
Direction
Driver's Cell Phone Number (tap to call)

### 4. APPLICATION USER INTERFACE

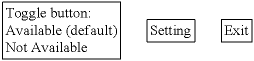

The TaxiZag user's interface is the same for taxi drivers and taxi customers (a single application for both). A configuration setting file will be stored on the mobile phone. The configuration can be changed later through accessing the “Setting” feature The installed TaxiZag application knows that it is used by a customer or a taxi driver thorough its configuration setting.

Starting TaxiZag displays a map (licensed from Google) with a top banner and bottom banner. On the bottom banner the following items are displayed:
Name of the application (Clicking on the name of the application opens an Info page that displays product, legal and contact information. The info page has one button on the top to go back to the map.)
An icon on the map is available to re-center the map (when the button is pressed, the map is re-centered to the location of the mobile phone and the map scale is set to a predefined value. When a user starts the application, the map will be displayed and centered to the current location of the user.) When a user starts the application, the map will be displayed and centered to the current location of the user.
The map can be zoomed and panned through multi-touch.

The top banner holds a jpeg graphics that is supplied by calling the web service that returns the locations.

On the map, two types of icons are used, one denotes taxis and the other represents customers. An “Exit” button is needed to terminate the application explicitly.

When application starts, a map is shown with available taxis and available customers. The user interface will have a toggle button labeled “I am not available” in order to change the status.

[Status] available/not available

### 5. SYSTEM PROCESS

TaxiZag continuously updates its location and locations of other customers or taxi drivers on the map at least every 3 seconds.

TaxiZag reports locations along with the attributes such as identifying the user as a customer or a taxi driver and display radius.

The locations of taxi customers and taxi drivers as well as the banners must be updated and displayed on the map in real-time.

1. A TaxiZag system comprising: a mobile application being installed on smart mobile phones; and a cloud computing component supporting the mobile application through which hardware, software, and network resources are optimally leveraged; wherein said mobile application and said cloud computing component send and receive data from each other in an automated fashion.

2. The TaxiZag system of claim 1 wherein said mobile application provides a geographic map that displays available taxis and customers as different image icons, which are touchable to conduct direct communication between taxi customers and taxi drivers without needing to call taxi companies.

3. The TaxiZag system of claim 1 wherein said mobile application enables a user to check real-time traffic condition by touching the image icon of another user.
